(19) United States
(12) Patent Application Publication
(10) Pub. No.: US 2019/0200055 A1
(43) Pub. Date: Jun. 27, 2019

(54) PACKET CONVERTER

(71) Applicant: PIXELWORKS, INC., Portland, OR (US)

(72) Inventor: KAZUYOSHI EBATA, Tokyo (JP)

(21) Appl. No.: 16/207,951

(22) Filed: Dec. 3, 2018

(30) Foreign Application Priority Data
Dec. 27, 2017 (JP) 2017-252563

(51) Int. Cl. H04N 21/2343; H04N 21/4402; H04N 21/435; H04N 21/8547; H04N 21/236; H04N 21/434; H04N 21/2381; H04N 21/44; H04N 21/234

(52) U.S. Cl. CPC H04N 21/234336; H04N 21/440218; H04N 21/4351; H04N 21/8547; H04N 21/23406; H04N 21/4343; H04N 21/2381; H04N 21/44004; H04N 21/23605

(57) ABSTRACT

A packet converter according to an embodiment is mountable on a digital broadcast receiver. The packet converter includes: a variable-length packet acquirer configured to acquire a variable-length packet acquired by receiving digital broadcast signals; an analyzer configured to analyze at least a header between the header and a payload of the variable-length packet; a packet reassembler configured to reassemble, from the variable-length packet, a plurality of transport stream (TS) packets each having a TS header, wherein the packet reassembler is configured to set a value of a packet ID (PID) in the TS header based at least on an analysis result of the header of the variable-length packet; and a TS packet outputter configured to output the plurality of TS packets.

### CROSS REFERENCE TO RELATED APPLICATION

This application claims the benefit of Japanese Patent Application No. 2017-252563 filed Dec. 27, 2017, the entire contents of which are incorporated herein by reference.

### TECHNICAL FIELD

The present disclosure relates to a packet converter for a digital broadcast receiver.

### BACKGROUND

In the related art of digital broadcasting, video signals and audio signals are multiplexed and transmitted in the MPEG2-TS format. More specifically, a transmitter in a digital broadcast system transmits digital broadcast signals that includes a transport stream (TS) of fixed-length (188 bytes) TS packets. A receiver that receives the digital broadcast signals includes a signal processor (SoC, or System on Chip) having a TS input, and the TS signal processor that processes the TS packets.

In ultra-high vision broadcast satellite digital broadcasting and next-generation digital terrestrial television broadcasting, variable-length packets in which IP packets are encapsulated may be transmitted. These variable-length packets may be referred to as TLV (Type Length Value) packets. Development of a signal processor that supports the TLV system is high in cost. However, converting variable-length packets into fixed-length packets to be input into existing TS signal processors can reduce the development cost.

An example of a method for converting a variable-length packet into a fixed-length packet may include segmenting a variable-length packet in the unit of 188 bytes in a receiver, and outputting the segmented data acquired by the segmentation, has been proposed (for example, see Japanese Patent Application Publication No. 2015-80029).

However, if the variable-length packet is merely segmented into the unit of 188 bytes and input into an existing TS signal processor, an issue may arise because data necessary to suitably process the TS is insufficient, and the existing TS signal processor is not able to perform efficiently.

The present disclosure provides a packet converter that converts a variable-length packet into a packet capable of being efficiently processed by an existing TS signal processor.

### SUMMARY

A packet converter according to an embodiment is mountable on a digital broadcast receiver. The packet converter includes: a variable-length packet acquirer configured to acquire a variable-length packet acquired by receiving digital broadcast signals; an analyzer configured to analyze at least a header between the header and a payload of the variable-length packet; a packet reassembler configured to reassemble, from the variable-length packet, a plurality of transport stream (TS) packets each having a TS header, wherein the packet reassembler is configured to set a value of a packet ID (PID) in the TS header based at least on an analysis result of the header of the variable-length packet; and a TS packet outputter configured to output the plurality of TS packets.

### BRIEF DESCRIPTION OF DRAWINGS

FIGS. 1A and 1B illustrate a configuration of a digital broadcast receiver according to an embodiment.

FIGS. 2A to 2C illustrate a configuration of a TLV packet, FIGS. 2D and 2E illustrate a configuration of a TLV packet, and FIG. 2F illustrates a configuration of a TS packet, which are processed in a digital broadcast receiver according to an embodiment.

FIG. 3 illustrates an operation example of an analyzer according to an embodiment.

FIGS. 4A to 4E illustrate an operation example of a TS packetizer according to an embodiment.

FIGS. 5A to 5E illustrate configuration examples of the last TS packet according to an embodiment.

FIG. 6 illustrates stuffing with respect to an MMTP packet according to an embodiment.

FIGS. 7A to 7F illustrate a modification of an embodiment.

### DETAILED DESCRIPTION OF THE EMBODIMENTS

Embodiments of the present disclosure is described with reference to the drawings.

Digital Broadcast Receiver

A digital broadcast receiver according to an embodiment will be described. The digital broadcast receiver according to an embodiment is used in digital broadcast systems, such as an ultra-high vision (or super high vision) broadcast satellite digital broadcast system or a next-generation digital terrestrial television broadcast system. The digital broadcast receiver is, for example, a digital television broadcast tuner, a video recorder with a built-in tuner, or a television set with a built-in tuner.

In an embodiment, an example in which a digital broadcast receiver receives digital broadcast signals using the ISDB-S3 (Integrated Services Digital Broadcasting for Satellite, 3rd generation) standard, which is a satellite digital broadcast format for the 4K or 8K resolution digital broadcasting, will be described.

In this digital broadcast system, digital data is transferred by using variable-length packets. In an embodiment, an example in which variable-length packets are TLV (Type Length Value) packets prescribed in, for example, the ARIBSTD-B32 Part 3 (Association of Radio Industries and Business Standard B32 part 3) will be described.

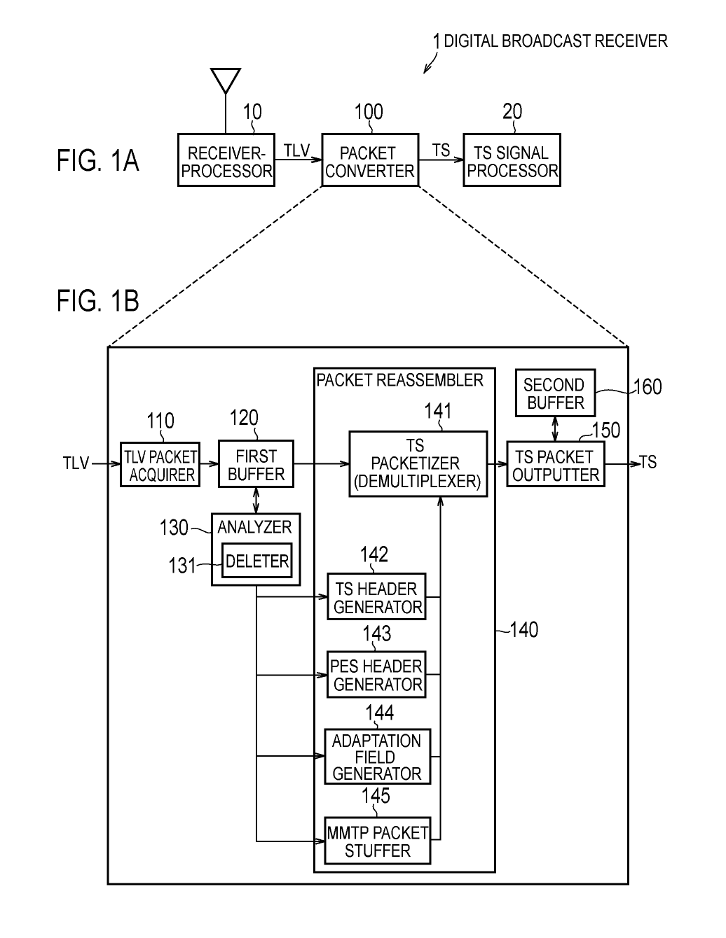

FIGS. 1A and 1B illustrate a configuration of a digital broadcast receiver 1 according to an embodiment. As illustrated in FIG. 1A, the digital broadcast receiver 1 includes a receiver-processor 10, a packet converter 100, and a TS signal processor 20. The receiver-processor 10, the packet converter 100 and the TS signal processor 20 are each formed as a system LSI (Large Scale Integration such as an SoC, System on a Chip) to be mounted on the digital broadcast receiver 1.

The receiver-processor 10 receives as an input a digital broadcast signal (a received signal) by an antenna, performs receiving processes to the received digital broadcast signal (for example, A/D conversion, demodulation, and error correction) to extract a TLV packet, and outputs the extracted TLV packet in synchronization with a clock signal 1. The receiver-processor 10 may output the clock signals and the TLV packets and, further, may output synchronization signals indicating a section of a synchronization pattern of a TLV packet header, signals indicating a valid data section, and signals indicating presence or absence of an error (an error bit).

The packet converter 100 acquires a TLV packet output from the receiver-processor 10, converts the acquired TLV packet into a TS packet, and outputs the TS packet in synchronization with a clock signal 2.

Generally, a TLV packet has a longer packet length than a TS packet does. Therefore, the packet converter 100 usually converts a single TLV packet into a plurality of TS packets and outputs. Note that the packet length of the TLV packet can be shorter than the packet length of the TS packet. Below, a case in which the packet converter 100 converts a single TLV packet into a plurality of TS packets and outputs will be mainly described.

The clock signal 2 on an output side of the packet converter 100 may be asynchronous with the clock signal 1 and may have a clock frequency different from that of the clock signal 1 on an input side of the packet converter 100.

The TS signal processor 20 is an existing signal processor having TS input. The TS signal processor 20 acquires TS packets output from the packet converter 100, and processes the acquired TS packets using an existing method.

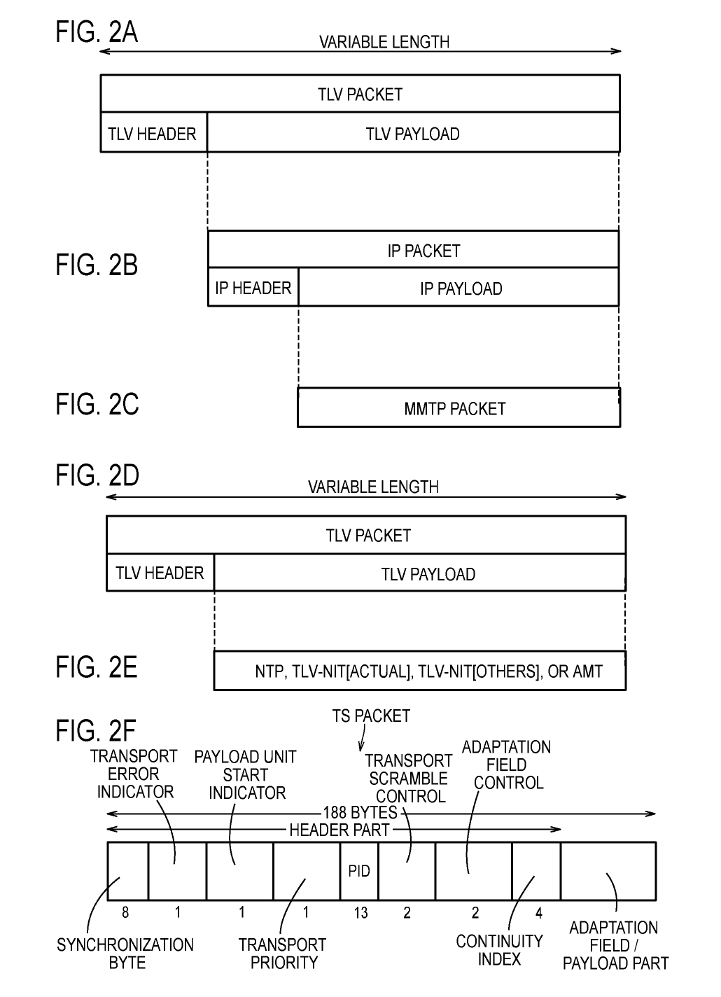

FIGS. 2A to 2C illustrate a configuration of a TLV packet, FIGS. 2D and 2E illustrate a configuration of a TLV packet, and FIG. 2F illustrates a configuration of a TS packet, which are processed in the digital broadcast receiver 1 according to an embodiment.

As illustrated in FIG. 2A, a TLV packet is formed by a TLV header and a TLV payload. The TLV payload may be referred to as a Value field. The TLV header includes a synchronization pattern, a packet Type field, and a Length field. Data indicating the type of the data contained in the TLV payload is contained in the Type field. Data indicating the data length of the TLV payload is contained in the Length field.

An IP packet in which an MMTP (MPEG Media Transport Protocol) packet is encapsulated or a TLV-SI (TLV transmission control signal) and the like, is contained in the TLV payload. A header of an IP packet in which an MMTP packet is encapsulated is compressed, and such an IP packet is referred to as a compressed IP packet. Examples of the TLV-SI may include an NTP (Network Time Protocol), an NIT (Network Information Table) and an AMP (Address Map Table). In the examples of FIGS. 2B and 2C, the compressed IP packet is contained in the TLV payload, and an MMTP packet is contained in a payload of the compressed IP packet. In the examples of FIGS. 2D and 2E, the TLV-SI (NTP/NIT/AMP) is contained in the TLV payload. In the MMT system, the unit that is independently decryptable, such as a video GOP (Group of Pictures) in the encrypted data, is defined as an MPU (Media Processing Unit), and the unit of a single video frame, and the like is defined as an MFU (Media Fragment Unit). The MFU is contained in the MMTP payload.

As illustrated in FIG. 2F, the TS packet is a 188-byte-long fixed-length packet. The TS packet is formed by a 4-byte-long TS header (a header part) and a TS payload. The TS header includes a 13-bit-long PID (Packet ID) used for the identification of the packet. In the MPEG2-TS format, after the encrypted data is encapsulated in the unit of a single video frame and the like as a PES (Packetized Elementary Stream), a PES packet is segmented and contained in the TS packet. A single PES packet is arranged in the payload of each TS packet having the same PID and in a segmented manner. Therefore, data of a plurality of PES packets is not contained in a single TS packet.

Packet Converter

Below, the packet converter 100 according to an embodiment will be described. As illustrated in FIG. 1B, the packet converter 100 includes a TLV packet acquirer 110, a first buffer 120, an analyzer 130, a packet reassembler 140, a TS packet outputter 150, and a second buffer 160.

The TLV packet acquirer 110 acquires a variable-length packet acquired upon reception of the digital broadcast signals. More specifically, the TLV packet acquirer 110 acquires (captures) a TLV packet output from the receiver-processor 10 based on a synchronization signal indicating a section of a synchronization pattern of the TLV packet head. The TLV packet acquirer 110 can recognize a start position of the TLV packet based on a change point of the synchronization signal.

The TLV packet acquirer 110 may determine whether the acquired TLV packet includes an error using the error bit output from the receiver-processor 10. If an error is included in the acquired TLV packet, the packet converter 100 does not necessarily have to output a TS packet corresponding to this TLV packet and may output an invalid packet (a null packet) corresponding to this TLV packet.

The first buffer 120 temporarily holds the TLV packet acquired by the TLV packet acquirer 110. The first buffer 120 holds the TLV packet for the time necessary for the analyzer 130 to analyze, and for the time necessary for the packet reassembler 140 to generate various headers, and the like.

The analyzer 130 analyzes the TLV packet held by the first buffer 120. The analyzer 130 analyzes at least the header between the header and the payload of the TLV packet.

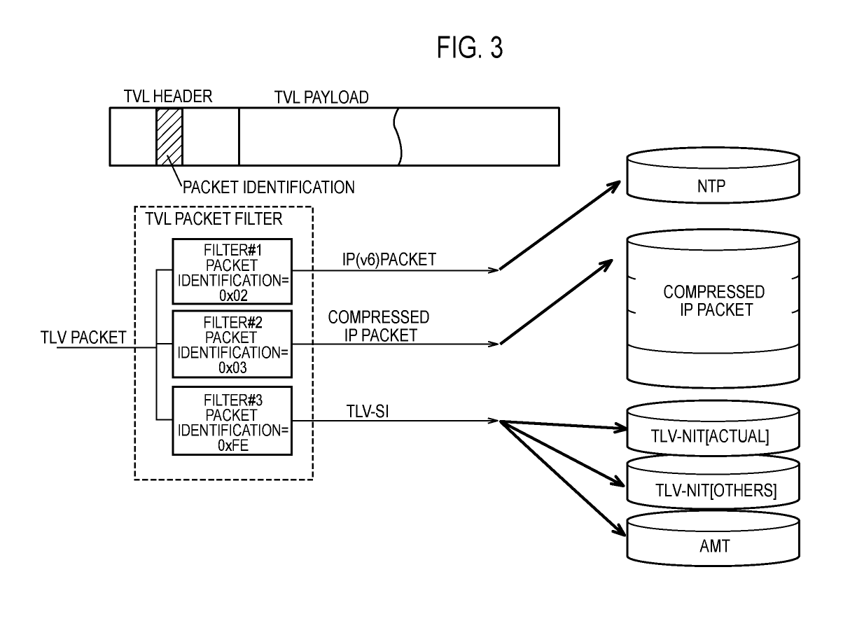

FIG. 3 illustrates an operation example of the analyzer 130. As illustrated in FIG. 3, the analyzer 130 analyzes a packet type field in the TLV header, and determines the contents of the TLV payload based on the value in the packet type field.

More specifically, if the value in the packet type field is “0 x 02,” the analyzer 130 determines that an IP packet (that is, NTP) is contained in the TLV payload. If the value in the packet type field is “0 x 03,” the analyzer 130 determines that a compressed IP packet (that is, an MMTP packet) is contained in the TLV payload.

If the value in the packet type field is “0 x FE,” the analyzer 130 determines that a TLV-SI (TLV-Signaling Information) which is a TLV transmission control signal is contained in the TLV payload. In this case, the analyzer 130 further analyzes a table ID contained in the TLV payload. If the value of the table ID is “0 x 40,” the analyzer 130 determines that a TLV-NIT (actual) is contained in the TLV payload. If the value of the table ID is “0 x 41,” the analyzer 130 determines that a TLV-NIT (others) is contained in the TLV payload. In the value of the table ID is “0 x FE,” the analyzer 130 determines that an AMT is contained in the TLV payload. The TLV-NIT is a network information table prescribed by the MPEG-2 system. The TLV-NIT (actual) is mainly used and the TLV-NIT (others) is other than the TLV-NIT (actual).

The analyzer 130 may further analyze the length field in the TLV header and, based on the analysis result, may determine the number of TS packets to be reassembled, and whether a null exists in the last TS packet.

The analyzer 130 includes a deleter 131. Regarding the TLV packet held by the first buffer 120, if the value in the packet type field is neither “0 x 02,” “0 x 03,” nor “0 x FE,” the deleter 131 determines that the TLV packet is an unnecessary TLV packet, and deletes the TLV packet. Also, the deleter 131 deletes the TLV header after the analysis.

If a compressed IP packet is contained in the payload of the TLV packet, the deleter 131 at least partially deletes data in the header of the compressed IP packet. The compressed IP packet includes an IP header (a header part) and an IP payload (a data part). The IP header includes a context identifier (CID), a sequence number (SN), a context identification header type CID header type), and a compressed header. The analyzer 130 (the deleter 131) deletes the context identifier (CID) and the sequence number (SN), and analyzes the context identification header type (CID header type). If the context identification header type (CID header type) is “0 x 60,” the analyzer 130 (the deleter 131) determines that the compressed header in the IP header (the header part) to be a partial IPv6 header and a partial UDP (User Datagram Protocol) header. The partial IPv6 header includes “version,” “traffic class,” “flow label,” “next header,” “hop limit,” “source address,” and “destination address.” The partial UDP header includes “source port” and “destination port.” The deleter 131 deletes the partial IPv6 header and the partial UDP header. After the IP header is deleted, the MMTP packet remains.

In accordance with the analysis result by the analyzer 130, the packet reassembler 140 reassembles a plurality of TS packets each having a TS header from the TLV packet, and then outputs the TS packets. The packet reassembler 140 includes a TS packetizer 141, a TS header generator 142 that generates a TS header, a PES header generator 143 that generates a PES header, an adaptation field generator 144 that generates an adaptation field, and an MMTP packet stuffer 145 that stuffs the MMTP packet.

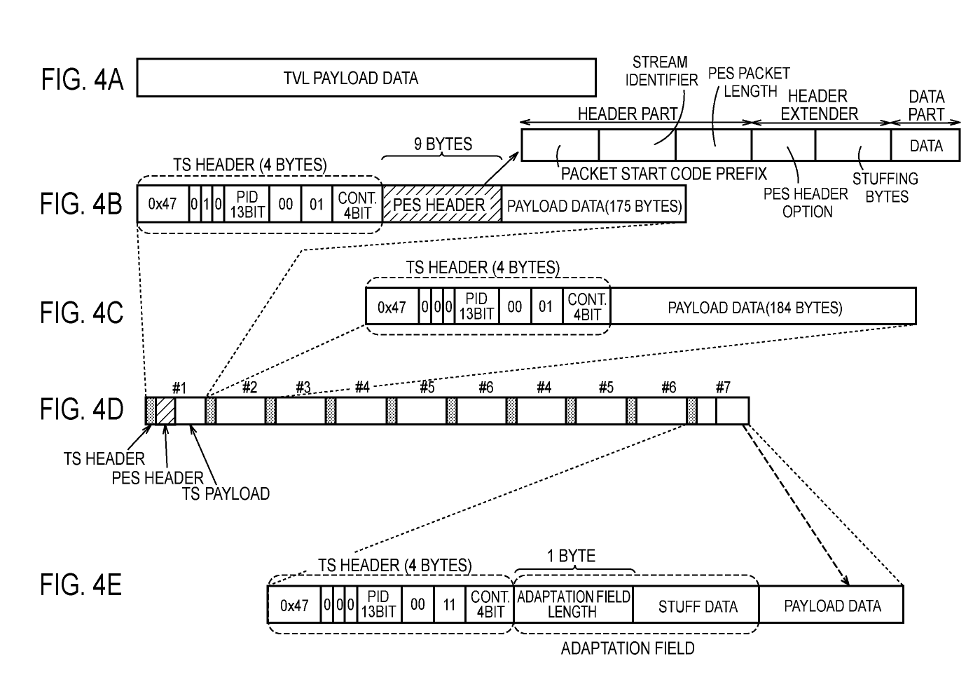

The TS packetizer 141 TS packetizes the payload of the TLV packet. FIGS. 4A to 4E illustrate an operation example of the TS packetizer 141.

As illustrated in FIG. 4A, data of the payload of the TLV packet is held in the first buffer 120. As illustrated in FIG. 4D, the TS packetizer 141 segments the TLV payload data and arranges the segmented data in a plurality of payloads of the TS packets. In the example of FIG. 4D, seven TS packets are reassembled with respect to a single TLV packet. Also, the TS packetizer 141 arranges each TS header input from the TS header generator 142 in a corresponding TS packet.

As illustrated in FIG. 4B, the TS packetizer 141 arranges the PES header (9 bytes) input from the PES header generator 143 in a head of the payload of the first TS packet #1. Also, the TS packetizer 141 arranges the data in the remaining payload area (175 bytes). Details of the PES header will be described later.

As illustrated in FIG. 4C, the TS packetizer 141 arranges merely data in the TS payload area (184 bytes) regarding TS packets #2 to #6 except the first TS packet #1 and the last TS packet #7.

As illustrated in FIG. 4E, the TS packetizer 141 arranges the adaptation field input from the adaptation field generator 144 in a head of a payload area of the last TS packet #7. As illustrated in FIG. 4E, the adaptation field includes “adaptation field length (Adaptation Field Length)” in which data indicating the adaptation field length is contained (1 byte), and stuff data having a length corresponding to the length of the null in the payload of the last TS packet #7.

The TS header generator 142 generates and outputs data to be contained in the TS header of the TS packet. Examples of the data to be contained in the TS header may be a PID (see FIG. 2D). The TS header generator 142 sets a value of the PID in the TS header based on the analysis result by the analyzer 130. The value of the PID is determined in the MPEG2-TS format. The TS header generator 142 determines the values of the PID as (1) to (5) below.
(1) Packet type “0 x 02” (that is, NTP): PID=0 x 010
(2) Packet type “0 x 03” (that is, compressed IP packet): PID=0 x 011
(3) Packet type “0 x FE” and table ID “0 x 40” (that is, TLV-NIT (actual)): PID=0 x 100
(4) Packet type “0 x FE” and table ID “0 x 41” (that is, TLV-NIT (others)): PID=0 x 101
(5) Packet type “0 x FE” and table ID “0 x FE” (that is, AMT): PID=0 x 110

The PES header generator 143 generates and outputs a PES header in the MPEG2-TS format. As described above, the PES header is arranged in the payload of the first TS packet by the TS packetizer 141. As illustrated in 4B, the PES header includes a header part formed by a 3-byte-long “packet start code,” a 1-byte-long “stream identifier,” and a 2-byte-long “PES packet length,” a header extender formed by a 1-byte-long “PES header option” and a 1-byte-long “stuffing byte,” and a 1-byte-long “data part.”

For example, the PES header generator 143 sets “0 x 000001” to the “packet start code,” “0 x E0” to the “stream identifier,” and “0 x 0000” to the “PES packet length.” Here, a value indicating that the length of the PES packet is unknown is set as the value of the “PES packet length.” Even if the value is set in this manner, the adaptation field described below can indicate the last TS packet including a trailer of the PES packet. Alternatively, the PES header generator 143 may calculate the PES packet length based on the data in the Length field in the TLV header and may arrange the calculated PES packet length in the “PES packet length” in the PES header.

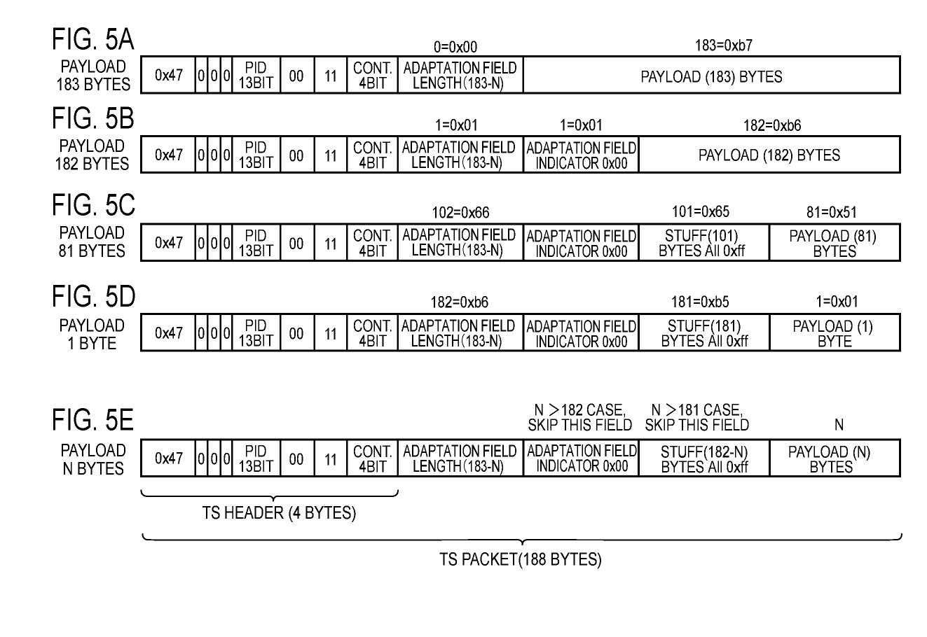

If a null exists in the payload of the last TS packet, the adaptation field generator 144 generates an adaptation field in the MPEG2-TS format. As described above, the adaptation field is arranged in the payload of the last TS packet by the TS packetizer 141. FIGS. 5A to 5E illustrate configuration examples of the last TS packet.

As illustrated in FIG. 5A, if the data to be arranged in the payload of the last TS packet is 183 bytes, a null of 1 byte exists with respect to the payload capacity of 184 bytes. In this case, the adaptation field generator 144 includes a value indicating 0 byte in the 1-byte-long “adaptation field length.” The TS packetizer 141 arranges the “adaptation field length” and 183-byte-long data (payload) in the payload of the TS packet.

As illustrated in FIG. 5B, if the data to be arranged in the payload of the last TS packet is 182 bytes, a null of 2 bytes exists with respect to the payload capacity of 184 bytes. In this case, the adaptation field generator 144 includes a value indicating 1 byte in the “adaptation field length” field. Also, the adaptation field generator 144 generates the “adaptation field indicator” (Adaptation Field Indicator). The TS packetizer 141 arranges the “adaptation field length” field, the “adaptation field indicator” field, and 182-byte-long data (payload) in the payload of the TS packet.

As illustrated in FIG. 5C, if the data to be arranged in the payload of the last TS packet is 81 bytes, a null of 103 bytes exists with respect to the payload capacity of 184 bytes. In this case, the adaptation field generator 144 includes a value indicating 102 bytes in the “adaptation field length” field. Also, the adaptation field generator 144 generates the “adaptation field indicator” and generates 101-byte-long stuff data. The TS packetizer 141 arranges the “adaptation field length” field, the “adaptation field indicator” field, the 101-byte-long stuff data, and 81-byte-long data (payload) in the payload of the TS packet.

As illustrated in FIG. 5D, if the data to be arranged in the payload of the last TS packet is 1 byte, a null of 183 bytes exists with respect to the payload capacity of 184 bytes. In this case, the adaptation field generator 144 includes a value indicating 182 bytes in the “adaptation field length” field. Also, the adaptation field generator 144 generates the “adaptation field indicator” and generates 181-byte-long stuff data. The TS packetizer 141 arranges the “adaptation field length” field, the “adaptation field indicator” field, the 181-byte-long stuff data, and 1-byte-long data (payload) in the payload of the TS packet.

As illustrated in FIG. 5E, if a data length N of the data to be arranged in the payload of the last TS packet is longer than 181, the stuff data is skipped, and if N is longer than 182, the “adaptation field indicator” is also skipped.

If the compressed IP packet including the MMTP packet is contained, the MMTP packet stuffer 145 arranges the stuff data between a header and the payload of the MMTP packet. Before the processing by the MMTP packet stuffer 145, the analyzer 130 analyzes the header of the MMTP packet and determines a start position of the payload of the MMTP packet in the payload of the TLV packet.

The payload of the MMTP packet is encrypted a predetermined data length (for example, 8 bytes) being one 1 unit, and decrypting is started at a predetermined data position determined depending on a predetermined data length. For example, AES (Advanced Encryption Standard) is used for encryption. The encrypted MMTP payload is decrypted by the TS signal processor 20.

If the start position of the payload of the MMTP packet does not match the predetermined data position, the MMTP packet stuffer 145 arranges the stuff data between the header and the payload of the MMTP packet. As a result, the start position of the payload of the MMTP packet matches the predetermined data position (that is, the decrypting start position).

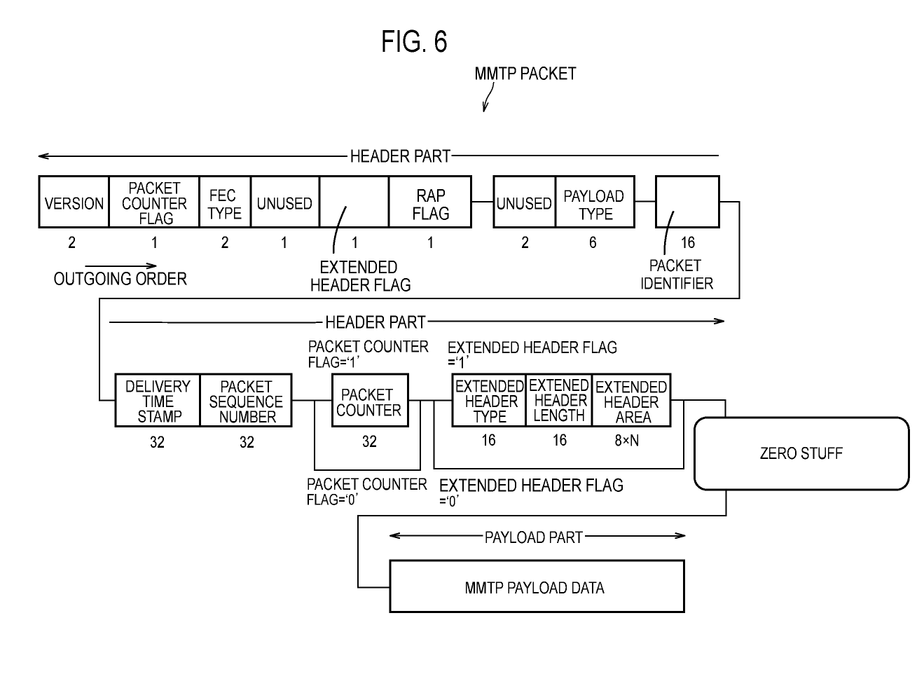

FIG. 6 illustrates stuffing with respect to the MMTP packet.

As illustrated in FIG. 6, the MMTP packet is formed by an MMTP header (a header part) and an MMTP payload (a payload part). The analyzer 130 analyzes a packet counter flag in the MMTP header, and determines whether a “packet counter” field exists in the MMTP header. The analyzer 130 analyzes an extended header flag in the MMTP header, and determines whether an “extended header type” field, an “extended header length” field, and an “extended header area” field exist in the MMTP header. Presence or absence of these fields determines a start position of the payload in the MMTP packet. The analyzer 130 calculates the start position of the MMTP payload in accordance with the head of the MMTP packet depending on the presence or the absence of these fields. If the calculated start position is not a multiple of 8 bytes (64 bits), the MMTP packet stuffer 145 arranges the stuff data (all zero) before the MMTP payload so that the start position of the MMTP payload is a multiple of 8 bytes (64 bits).

The TS packet outputter 150 outputs a plurality of TS packets input from the TS packetizer 141 to the outside (that is, the TS signal processor 20). The TS packet outputter 150 serializes the TS packet and outputs the TS packet (TS signals) in synchronization with the clock signals.

The second buffer 160, temporarily holds TS packets that have not been output from the TS packet outputter 150. If an output bit rate (an output clock frequency) of the packet converter 100 is higher than an input bit rate (an input clock frequency) of the packet converter 100, the second buffer 160 uses a difference in the bit rate between input and output.

The packet converter 100 according to an embodiment is mountable on the digital broadcast receiver 1. The packet converter 100 includes the TLV packet acquirer 110 that acquires a TLV packet acquired upon reception of digital broadcast signals, the analyzer 130 that analyzes at least a header between the header and the payload of the TLV packet, the packet reassembler 140 that reassembles, from the TLV packet, a plurality of TS packets each having a TS header, and the TS packet outputter 150 that outputs a plurality of TS packets. The packet reassembler 140 sets a value of the PID in the TS header based at least on the analysis result of the header of the TLV packet. With this configuration, the packet reassembler 140 can suitably set the value of PID in the TS header based on the analysis result of the header of the TLV packet. Therefore, the existing TS signal processor 20 can suitably distinguish the contents of each TS packet based on the PID and efficiently process each TS packet.

In an embodiment, the packet reassembler 140 arranges a PES header in the MPEG2-TS format in the payload of the first TS packet among a plurality of TS packets. With this configuration, the existing TS signal processor 20 can recognize that a single PES packet is assembled by a plurality of TS packets output from the packet converter 100. Therefore, the existing TS signal processor 20 can efficiently process each TS packet. More specifically, if the TS signal processor 20 recognizes that a PES packet is assembled by a plurality of TS packets, the TS signal processor 20 can automatically delete the TS header and can write merely the payload data in memory considering the PES packet length and the adaptation field.

In an embodiment, if a null exists in the payload of the last TS packet among a plurality of TS packets, the packet reassembler 140 arranges an adaptation field in the MPEG2-TS format in that payload. Therefore, even if a null exists in the payload of the last TS packet, the last TS packet can be the TS packet interchangeable with the MPEG2-TS. Also, the adaptation field can make the existing TS signal processor 20 recognize the last TS packet.

In an embodiment, the packet converter 100 includes the deleter 131 that deletes the header of the TLV packet. If a compressed IP packet is contained in the payload of TLV packet, the deleter 131 further deletes at least partially the data of the header of the compressed IP packet. Therefore, data not needed by the existing TS signal processor 20 is deleted and the TS packet can be efficiently processed. Also, an increase in amount of output data of the packet converter 100 can be avoided.

In an embodiment, the packet converter 100 further includes a buffer 160 (a second buffer) for temporarily holding TS packets that have not been output from the TS packet outputter 150. If an output bit rate of the packet converter 100 is higher than an input bit rate of the packet converter 100, the buffer 160 is used to absorb a difference in the bit rate between input and output. Therefore, TS packetization increases the amount of data and, if a bit rate difference is caused between input and output, the difference in the bit rate can be absorbed by the buffer.

In an embodiment, if a compressed IP packet including an MMTP packet is contained in the payload of the TLV packet, the analyzer 130 analyzes a header of the MMTP packet and determines a start position of the payload of the MMTP packet. The payload of the MMTP packet is encrypted a predetermined data length (for example, 8 bytes) being one unit, and decrypting is started at a predetermined data position determined depending on a predetermined data length. If the start position of the payload of the MMTP packet does not match the predetermined data position, the packet reassembler 140 arranges the stuff data between the header and the payload of the MMTP packet. Therefore, the existing TS signal processor 20 can suitably decrypt the payload of the MMTP packet.

Modification

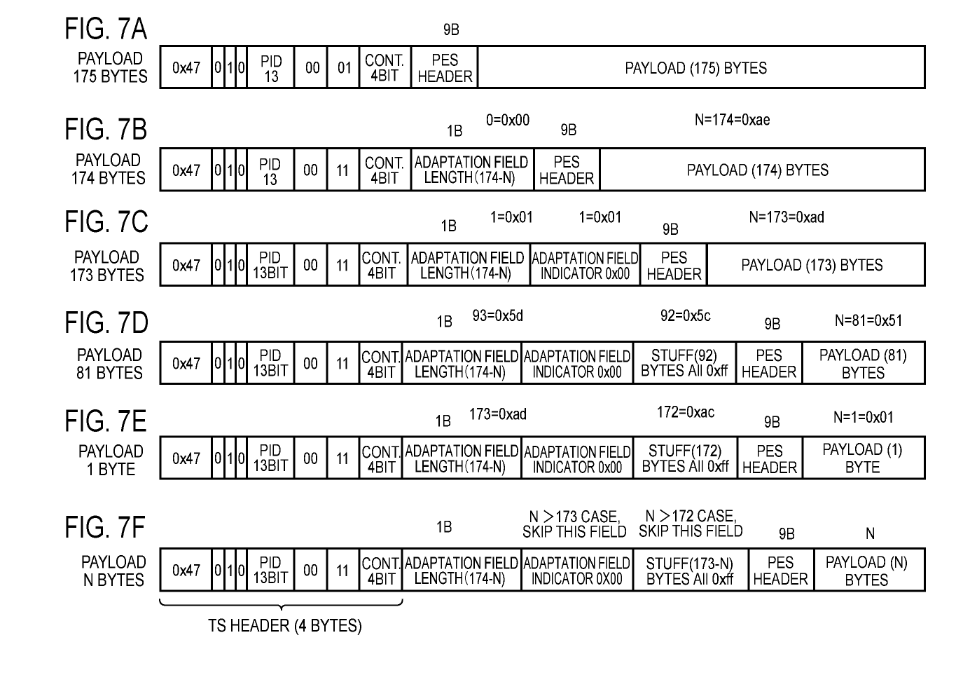

In this modification, an operation example in which the packet length of the TLV packet is very short will be described. In this case, a single TS packet can be reassembled from a single TLV packet. FIGS. 7A to 7F illustrate an example of an alternative embodiment.

As illustrated in FIG. 7A, if the payload data to be contained in the TS packet is 175 bytes long, a 9-byte-long PES header and 175-byte-long payload data are arranged in the payload area of the TS packet.

As illustrated in FIG. 7B, if the payload data to be contained in the TS packet is 174 bytes long, a 1-byte-long adaptation field length, a 9-byte-long PES header and 174-byte-long payload data are arranged in this order in the payload area of the TS packet.

As illustrated in FIG. 7C, if the payload data to be contained in the TS packet is 173 bytes long, a 1-byte-long adaptation field length, a 1-byte-long adaptation field indicator, a 9-byte-long PES header, and 173-byte-long payload data are arranged in this order in the payload area of the TS packet.

As illustrated in FIG. 7D, if the payload data to be contained in the TS packet is 81 bytes long, a 1-byte-long adaptation field length, a 1-byte-long adaptation field indicator, 92-byte-long stuff data, a 9-byte-long PES header, and 81-byte-long payload data are arranged in this order in the payload area of the TS packet.

As illustrated in FIG. 7E, if the payload data to be contained in the TS packet is 1 byte long, a 1-byte-long adaptation field length, a 1-byte-long adaptation field indicator, 172-byte-long stuff data, a 9-byte-long PES header, and 1-byte-long payload data are arranged in this order in the payload area of the TS packet.

As illustrated in FIG. 7D, if the payload data length N to be contained in the TS packet is longer than 172, the stuff data is skipped and, if N is longer than 173, the “adaptation field indicator is also” skipped.

### OTHER EMBODIMENTS

The present disclosure has been described with reference to the embodiments. However, it is not to be understood that discussion and drawings that are parts of the disclosure of the disclosure are limiting the disclosure. Various alternative embodiments, examples, and operational techniques will become obvious to those skilled in the art from the described embodiments.

In the above embodiment, the TS signal processor 20 may record each TS packet input from the packet converter 100 a time stamp added to each TS packet. Each recorded TS packet can be reassembled in another place later. Therefore, even in places in which no 4K or 8K resolution digital broadcasting signals reach, video and audio of 4K or 8K resolution digital broadcasting can be reproduced using each recorded TS packet.

In the above embodiments, an example in which the packet converter 100 is a device different from the receiver-processor 10 (different SoC), and the packet converter 100 is a device different from the TS signal processor 20 (different SoC) has been described. However, the packet converter 100 may be incorporated in the receiver-processor 10 or in the TS signal processor 20. For example, the packet converter 100 may be incorporated in the receiver-processor 10, and the packet converter 100 and the receiver-processor 10 may be formed as a single SoC. The packet converter 100 may be incorporated in the TS signal processor 20, and the packet converter 100 and the TS signal processor 20 may be formed as a single SoC. Any or all of these SoCs may execute code that causes the various functions of the packet converter, the receiver-processor and the TS signal processor to be performed.

In the above embodiments, an example in which the variable-length packet is a TLV packet has been described. However, the variable-length packet is not limited to the TLV packet, and the variable-length packet may be, for example, a GSE (Generic Stream Encapsulation) packet prescribed in the ETSI TS 102 606, and the like.

What is claimed is:

1. A packet converter mountable on a digital broadcast receiver, comprising:
a variable-length packet acquirer configured to acquire a variable-length packet acquired by receiving digital broadcast signals;
an analyzer configured to analyze at least a header between the header and a payload of the variable-length packet;
a packet reassembler configured to reassemble, from the variable-length packet, a plurality of transport stream (TS) packets each having a TS header, wherein the packet reassembler is configured to set a value of a packet ID (PID) in the TS header based at least on an analysis result of the header of the variable-length packet; and
a TS packet outputter configured to output the plurality of TS packets.

2. The packet converter according to claim 1, wherein
the packet reassembler is further configured to arrange, into a payload of an initial TS packet among the plurality of TS packets, a packetized elementary stream (PES) header in an MPEG2-TS format.

3. The packet converter according to claim 1, wherein
when a null exists in a payload of a last TS packet among the plurality of TS packets, the packet reassembler is further configured to arrange, into the payload of the last TS packet, an adaptation field in an MPEG2-TS format.

4. The packet converter according to claim 1, further comprising
a deleter configured to delete a header of the variable-length packet, wherein when a compressed internet protocol (IP) packet is contained in the payload of the variable-length packet, the deleter is configured to at least partially delete data in the header of the compressed IP packet.

5. The packet converter according to claim 1, further comprising
a buffer configured to temporarily hold a TS packet that has not been output from the TS packet outputter, wherein
when an output bit rate of the packet converter is higher than an input bit rate of the packet converter, the buffer is configured to absorb a difference in the bit rate between input and output.

6. The packet converter according to claim 1, wherein
when a compressed IP packet including an MPEG Media Transport Protocol (MMTP) packet is contained in the payload of the variable-length packet, the analyzer is further configured to analyze a header of the MMTP packet and to determine a start position of the payload of the MMTP packet,
the payload of the MMTP packet is encrypted a predetermined data length being one unit,
a decryption of the payload of the MMTP packet is started at a predetermined data position determined depending on the predetermined data length, and
when a start position of the payload of the variable-length packet does not match the predetermined data position, the packet reassembler is further configured to arrange stuff data between the header and the payload of the MMTP packet.

7. A digital broadcast receiver, comprising:
a receiver-processor to receive digital broadcast signals;
a packet converter including:
a variable-length packet acquirer configured to acquire a variable-length packet acquired by receiving the digital broadcast signals;
an analyzer configured to analyze at least a header between the header and a payload of the variable-length packet;
a packet reassembler configured to reassemble, from the variable-length packet, a plurality of transport stream (TS) packets each having a TS header, wherein the packet reassembler is configured to set a value of a packet ID (PID) in the TS header based at least on an analysis result of the header of the variable-length packet; and
a TS packet outputter configured to output the plurality of TS packets; and
a TS signal processor.

8. A packet converting method for a digital broadcast receiver, comprising:
acquiring a variable-length packet acquired by receiving digital broadcast signals;
analyzing at least a header between the header and a payload of the variable-length packet;
reassembling, from the variable-length packet, a plurality of transport stream (TS) packets each having a TS header, wherein the reassembling comprises setting a value of a packet ID (PID) in the TS header based at least on an analysis result of the header of the variable-length packet; and
outputting the plurality of TS packets.
